(19) United States
(12) Patent Application Publication
(10) Pub. No.: US 2013/0228336 A1
(43) Pub. Date: Sep. 5, 2013

(54) Methods for Servicing Subterranean Wells

(71) Applicants: Nicolas Droger, Paris (FR); Diankui Fu, Kuala Lumpur (MY)

(72) Inventors: Nicolas Droger, Paris (FR); Diankui Fu, Kuala Lumpur (MY)

(73) Assignee: SCHLUMBERGER TECHNOLOGY CORPORATION, Houston, TX (US)

(21) Appl. No.: 13/879,025

(22) PCT Filed: Nov. 12, 2010
(86) PCT No.: PCT/RU2010/000664

§ 371 Date: May 22, 2013

(51) Int. Cl. C09K 8/035; E21B 21/00

(52) U.S. Cl. CPC C09K 8/035; E21B 21/00
USPC 166/305.1

(57) ABSTRACT

Methods for controlling fluid flow through one or more pathways in one or more rock formations penetrated by a borehole in a subterranean well, comprise injecting into or adjacent to the formation a treatment fluid comprising at least one viscoelastic surfactant; fibers, or a mixture of fibers and particles; and one or more flocculation initiators. Flocculation of the mixture produces fibrous masses that migrate to formation-rock openings such as pores, cracks, fissures and vugs. As a result, the fibrous masses are useful for curing lost circulation, providing fluid-loss control and as diverting agents.

### BACKGROUND OF THE INVENTION

The statements in this section merely provide background information related to the present disclosure and may not constitute prior art.

This invention relates to methods for servicing subterranean wells, in particular, fluid compositions and methods for operations during which the fluid compositions are pumped into a wellbore, make contact with subterranean formations, and block fluid flow through one or more pathways in the subterranean formation rock.

During the construction and stimulation of a subterranean well, operations are performed during which fluids are circulated in the well or injected into formations that are penetrated by the wellbore. During these operations, the fluids exert hydrostatic and pumping pressure against the subterranean rock formations. The formation rock usually has pathways through which the fluids may escape the wellbore. Such pathways include (but are not limited to) pores, fissures, cracks, and vugs. Such pathways may be naturally occurring or induced by pressure exerted during pumping operations.

During well construction, drilling and cementing operations are performed that involve circulating fluids in and out of the well. If some or all of the fluid leaks out of the wellbore during these operations, a condition known as “fluid loss” exists. There are various types of fluid loss. One type involves the loss of carrier fluid to the formation, leaving suspended solids behind. Another involves the escape of the entire fluid, including suspended solids, into the formation. The latter situation is called “lost circulation”, it can be an expensive and time-consuming problem.

During drilling, lost circulation hampers or prevents the recovery of drilling fluid at the surface. The loss may vary from a gradual lowering of the mud level in the pits to a complete loss of returns. Lost circulation may also pose a safety hazard, leading to well-control problems and environmental incidents.

During cementing, lost circulation may severely compromise the quality of the cement job, reducing annular coverage, leaving casing exposed to corrosive downhole fluids, and/or failing to provide adequate zonal isolation.

Lost circulation may also be a problem encountered during well-completion and workover operations, potentially causing formation damage, lost reserves and even loss of the well.

Even if lost circulation is a decades-old problem, there is no single solution that can cure all lost-circulation situations. Lost-circulation solutions may be classified into three principal categories: bridging agents, surface-mixed systems and downhole-mixed systems. Bridging agents, also known as lost-circulation materials (LCMs), are solids of various sizes and shapes (e.g., granular, lamellar, fibrous and mixtures thereof). They are generally chosen according to the size of the voids or cracks in the subterranean formation and, as fluid escapes into the formation, congregate and form a barrier that minimizes or stops further flow.

One of the major advantages of using fibers is the ease with which they can be handled. A wide variety of fibers is available to the oilfield made from, for example, natural celluloses, synthetic polymers, and ceramics, minerals or glass. Most are available in various shapes, sizes, and flexibilities. Fibers generally decrease the permeability of a loss zone by creating a porous web or mat that filters out solids in the fluid, forming a low-permeability filter cake that can plug or bridge the loss zones. Typically, solids with a very precise particle-size distribution must be used with a given fiber to achieve a suitable filter cake. Despite the wide variety of available fibers, the success rate and the efficiency are not always satisfactory.

An extensive discussion of lost circulation and techniques by which it may be cured is presented in the following publication: Daccord G, Craster B, Ladva H, Jones T G J and Manescu G: “Cement-Formation Interactions,” in Nelson E B and Guillot D (eds.): Well Cementing (2^{nd} Edition), Schlumberger, Houston (2006) 191-219.

In the context of well stimulation, fluid loss is also an important parameter that must be controlled to achieve optimal results. In many cases, a subterranean formation may include two or more intervals having varying permeability and/or injectivity. Some intervals may possess relatively low injectivity, or ability to accept injected fluids, due to relatively low permeability, high in-situ stress and/or formation damage. When stimulating multiple intervals having variable injectivity it is often the case that most, if not all, of the introduced well-treatment fluid will be displaced into one, or only a few, of the intervals having the highest injectivity. Even if there is only one interval to be treated, stimulation of the interval may be uneven because of the in-situ formation stress or variable permeability within the interval. Thus, there is a strong incentive to evenly expose an interval or intervals to the treatment fluid; otherwise, optimal stimulation results may not be achieved.

In an effort to more evenly distribute well-treatment fluids into each of the multiple intervals being treated, or within one interval, methods and materials for diverting treatment fluids into areas of lower permeability and/or injectivity have been developed. Both chemical and mechanical diversion methods exist.

Mechanical diversion methods may be complicated and costly, and are typically limited to cased-hole environments. Furthermore, they depend upon adequate cement and tool isolation.

Concerning chemical diversion methods, a plethora of chemical diverting agents exists. Chemical diverters generally create a cake of solid particles in front of high-permeability layers, thus directing fluid flow to less-permeable zones. Because entry of the treating fluid into each zone is limited by the cake resistance, diverting agents enable the fluid flow to equalize between zones of different permeabilities. Common chemical diverting agents include bridging agents such as silica, non-swelling clay, starch, benzoic acid, rock salt, oil soluble resins, naphthalene flakes and wax-polymer blends. The size of the bridging agents is generally chosen according to the pore-size and permeability range of the formation intervals. The treatment fluid may also be foamed to provide a diversion capability.

In the context of well stimulation, after which formation fluids such as hydrocarbons are produced, it is important to maximize the post-treatment permeability of the stimulated interval or intervals. One of the difficulties associated with many chemical diverting agents is poor post-treatment cleanup. If the diverting agent remains in formation pores, or continues to coat the formation surfaces, production will be hindered.

A more complete discussion of diversion and methods for achieving it is found in the following publication: Provost L and Doerler N: “Fluid Placement and Diversion in Sandstone Acidizing,” in Economides M and Nolte K G (eds.): Reservoir Stimulation, Schlumberger, Houston (1987): 15-1-15-9.

Therefore, despite the valuable contributions of the prior art, there remains a need for improved materials and techniques for controlling the flow of fluids from the wellbore into formation rock. This need pertains to many operations conducted during both well construction and well stimulation.

### SUMMARY OF THE INVENTION

Embodiments provide improved means for solving the aforementioned problems associated with controlling fluid flow from the wellbore into formation rock.

In a first aspect, embodiments relate to methods for controlling fluid flow through one or more pathways in one or more rock formations penetrated by a borehole in a subterranean well.

In a further aspect, embodiments relate to methods for curing lost circulation in a subterranean well penetrated by a borehole.

In yet a further aspect, embodiments relate to methods of treating a subterranean formation penetrated by a wellbore.

### BRIEF DESCRIPTION OF THE DRAWINGS

FIG. 1 shows the pH and citric-acid-concentration ranges within which oleic acid is soluble and insoluble in water.

FIG. 2 is a schematic diagram of an apparatus for evaluating the plugging ability of a treatment fluid.

FIG. 3 is a detailed diagram of the slot of the apparatus depicted in FIG. 2.

FIG. 4 shows the result of a plugging experiment to evaluate citric acid as a flocculation initiator.

FIG. 5 is a graph concerning the precipitation of calcium oleate arising from the addition of calcium chloride.

FIG. 6 shows the result of a plugging experiment to evaluate calcium chloride as a flocculation initiator.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific points, it is to be understood that inventors appreciate and understand that any and all data points within the range are to be considered to have been specified, and that inventors possessed knowledge of the entire range and all points within the range.

Embodiments relate to methods for controlling fluid flow through pathways in rock formations penetrated by a borehole in a subterranean well. The disclosed methods are applicable to treatments associated with well-service activities that are conducted throughout the life of a well, including (but not limited to) well construction, well stimulation and workover operations.

The inventors have surprisingly discovered that fluids comprising one or more viscoelastic surfactants, fibers and one or more flocculation initiators may be useful for controlling fluid flow through openings in rock formations penetrated by a borehole in a subterranean well. Optionally, solid particles may be present in the fluids. Without wishing to be bound by any theory, the flocculation initiators are believed to cause the viscoelastic surfactant to precipitate, and the resulting precipitate is thought to bind the fibers (and, if present, solid particles), forming aggregates or flocs.

Without wishing to be bound by any theory, it is believed that when these fluids are injected in the wellbore during a pumping operation, the flocs will tend to congregate against, bridge or plug pathways in the formation rock through which wellbore fluids may flow. Such pathways may include (but not be limited to) pores, cracks, fissures and vugs. Furthermore, it is believed that the flocs will preferentially flow toward pathways accepting fluid at higher rates.

When the flocs congregate against the rock-formation pathways, they are believed to hinder further fluid flow. The inventors believe that this effect may be useful during a wide range of well-service operations, including (but not limited to) curing lost circulation during drilling and cementing, and providing fluid-loss control during drilling, cementing, matrix acidizing, acid fracturing, hydraulic fracturing, formation-consolidation treatments, sand-control treatments and workover operations. In the context of cementing, the flocs may be useful during both primary and remedial cementing. The flocs may also be particularly useful for providing fluid diversion when treating multiple formations with different permeabilities or injectivities, or a single formation whose permeability and injectivity are variable.

The treatment fluid may be an aqueous base fluid made with fresh water, seawater, brine, etc., depending upon compatibility with the viscosifier and the formation.

In an aspect, embodiments relate to methods for controlling fluid flow through one or more pathways in one or more rock formations penetrated by a subterranean well, comprising injecting into or adjacent to the formation a treatment fluid comprising: (1) at least one viscoelastic surfactant; (2) fibers, or a mixture of fibers and particles; and (3) one or more flocculation initiators.

In a further aspect, embodiments relate to methods for curing lost circulation in a subterranean well penetrated by a borehole, comprising injecting into or adjacent to the formation a treatment fluid comprising: (1) at least one viscoelastic surfactant; (2) fibers, or a mixture of fibers and particles; and (3) one or more flocculation initiators.

In yet a further aspect, embodiments relate to methods for treating a subterranean formation penetrated by a wellbore, comprising injecting into or adjacent to the formation a treatment fluid comprising: (1) at least one viscoelastic surfactant; (2) fibers, or a mixture of fibers and particles; and (3) one or more flocculation initiators. Those skilled in the art will appreciate that this aspect of the invention pertains to treatment fluids providing fluid-loss control, diversion or both.

The viscoelastic surfactants of the invention may be cationic (for example, quarternary ammonium compounds), anionic (for example, fatty-acid carboxylates), zwitterionic (for example, betaines) or nonionic and mixtures thereof. Without wishing to be bound by any theory, viscoelastic surfactants are believed to provide fluid viscosity by forming rod-like micelles. Entanglement of the micelles in the fluid is thought to create internal flow resistance that is in turn translated into viscosity. A thorough description of viscoelastic surfactants and the mechanisms by which they provide viscosity is given in the following publications. Zana R and Kaler E W (eds.): Giant Micelles, CRC Press, New York (2007). Abdel-Rahem V and Hoffmann H: “The distinction of viscoelastic phases from entangled wormlike micelles and of densely packed multilamellar vesicles on the basis of rheological measurements,” Rheologica Acta, 45 (6) 781-792 (2006). The viscosity provided by the viscoelastic surfactants may allow optimal fibers and solids transport and prevent bridging or plugging as the fluid is pumped to its destination through tubulars, tools or annuli. VES fluids are well known and used for various oilfield applications such as hydraulic fracturing, diversion in acidizing, and leakoff control. Further VES fluids useful as base fluids in the embodiments include, but are not limited to those available under the tradenames CLEARFRAC™, VDA™, OILSEEKER™ and CLEARPILL™, all of which are available from Schlumberger Limited. Non-limiting examples of suitable VES fluids are described, for example, in U.S. Pat. Nos. 5,964,295; 5,979,555; 6,637,517; 6,258,859; and 6,703,352.

In the various embodiments of the invention, the preferred viscoelastic-surfactant concentration may be between about 0.2% and 20% by weight, more preferably between about 0.3% and 10% by weight, and most preferably between about 0.5% and 5% by weight.

The fibers of the invention may comprise (but not be limited to) polylactic acid, polyester, polylactone, polypropylene, polyolefin or polyamide and mixtures thereof. The preferred fiber-length range is between about 2 mm and 25 mm, more preferably between about 3 mm and 18 mm, and most preferably between about 5 mm and 7 mm. The preferred fiber-diameter range is between about 1 μm to 200 μm, more preferably between about 1.5 μm to 60 μm, and most preferably between about 10 μm and 20 μm. One of the advantages offered by the aforementioned fibers is that, for example, the polypropylene and polyolefin fibers are soluble in liquid hydrocarbons such as crude oil, and the rest will degrade through hydrolysis in the presence of traces of water and heat. With time, they may dissolve and be carried away by the produced hydrocarbon fluid, providing improved cleanup and well production.

Mixtures of fibers may also be used, for example as described in U.S. Patent Application Publication No. 20100152070. For example, the fibers may be a blend of long fibers and short fibers. Preferably, the long fibers are rigid and the short fibers are flexible. It is believed that such long fibers form a tridimensional mat or net in the flow pathway that traps the particles, if present, and the short fibers.

When present, the solid particles may comprise (but not be limited to) polylactic acid, polyester, calcium carbonate, quartz, mica, clay, barite, hematite, ilmenite or manganese tetraoxide and mixtures thereof. The preferred solid-particle-size range is between about 5 μm and 1000 μm, more preferably between about 10 μM and 300 μm, and most preferably between about 15 μm to 150 μm. The preferred solid-particle concentration range is between about 6 g/L and 72 g/L, more preferably between about 12 g/L and 36 g/L, and most preferably between about 15 g/L and 20 g/L.

Depending on the nature of the viscoelastic surfactant, the flocculation initiator of the invention may be chosen from the list comprising acids, alkalis, multivalent ions, mutual solvents, surfactants, polymers, or oxidizers and combinations thereof. The flocculation initiator may also comprise acid precursors such as (but not limited to) esters, lactones, amides, lactams or acid anhydrides and mixtures thereof. Acid precursors may hydrolyze slowly, providing some delay in the flocculation and precipitation process. Furthermore, the flocculation initiator may be encapsulated to provide delayed flocculation and precipitation. Those skilled in the art will recognize that encapsulation refers to methods by which a material is isolated from the continuous phase of a fluid. Such isolation may be provided by (but would not be limited to) a shell coating or an emulsion. Mechanisms by which the encapsulated flocculation initiator may be released include (but would not be limited to) time, hydrolysis, temperature, shear (for example, through a drill bit), pH change, vibration or irradiation and combinations thereof.

The inventors have discovered that anionic fatty-acid carboxylates are particularly useful viscoelastic surfactants in the context of the invention, especially oleic acid. Furthermore, they discovered that particularly useful flocculation initiators include carboxylic acids and multivalent cations.

Preferred carboxylic acids comprise (but are not limited to) citric acid, acetic acid, formic acid, oxalic acid and benzoic acid. The preferred carboxylic-acid concentration is that which is sufficient to reduce the fluid pH to a level below about 9.5, more preferably below about 8, and most preferably below about 6.5. The pH decrease may be controlled by buffering the treatment fluid at a pH higher than about 9.5. Suitable buffers include (but are not limited to) sodium carbonate and/or sodium bicarbonate.

Preferred multivalent-cation compounds comprise (but are not limited to) calcium chloride, magnesium chloride, iron chloride, copper chloride, aluminum chloride, calcium hydroxide, calcium formate and calcium lactate gluconate. Of these, calcium chloride and calcium hydroxide are more preferred. The preferred multivalent-ion compound concentration may be between about 0.01% and 10% by weight, more preferably between 0.05% and 5.0% by weight, and most preferably between about 0.1% and 1.0% by weight.

The availability of the multivalent cations as flocculation initiators may be regulated, thereby preventing premature surfactant precipitation, by incorporating one or more chelating agents in the treatment fluid. Suitable chelating agents include (but are not limited to) ethylene diamine tetraacetic acid (EDTA), diethylene triamine pentaacetic acid (DTPA), hydroxyethyl ethylene diamine triacetic acid (HEDTA), hydroxyethyl iminodiacetic acid (HEIDA) or triethanolamine and mixtures thereof.

### EXAMPLES

The following examples serve to further illustrate the invention.

### Example 1

An aqueous viscoelastic surfactant base fluid was prepared with the following composition: 1.8 wt % oleic acid, 0.2 wt % acetic acid, 5 wt % KCl and 0.6 wt % NaOH. In this experiment, citric acid was evaluated as a flocculation initiator.

The base fluid was placed in a container suitable for conducting titrations. A pH electrode was immersed in the fluid, and the fluid pH was recorded as citric acid was added to the base fluid. In addition, the phase behavior of the fluid was observed during the titration.

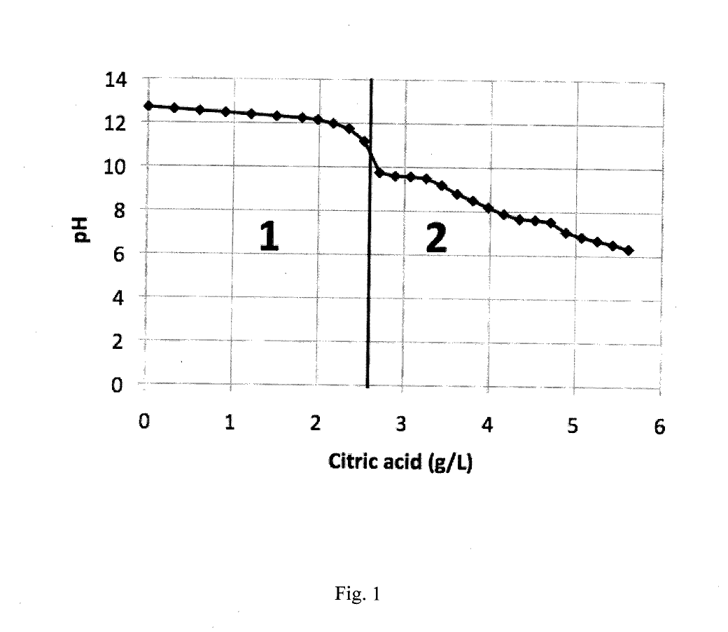

The titration curve is shown in FIG. 1. The initial base-fluid pH was 12.7. At this pH, the oleic species was a soluble oleate. Citric acid was added such that its concentration increased in 0.3-g/L increments. The pH decreased gradually until a downward inflection occurred at a citric-acid concentration of about 2.1 g/L. As additional citric acid was added, the fluid pH fell below about 9.5. An oily substance, oleic acid, began to precipitate. Additional precipitation occurred as more citric acid was introduced and, at a citric-acid concentration of 4.3 g/L (pH=7.6), all of the oleic acid had been removed from solution. Thus, Region 1 in FIG. 1 represents the pH and citric-acid-concentration range within which the oleate species is soluble. Region 2 represents the pH and citric-acid-concentration range within which the oleate species is insoluble.

### Example 2

350 mL of the base fluid described in Example 1 were prepared and placed in a beaker. Polylactic acid (PLA) fibers were then added to and manually dispersed throughout the base fluid at a concentration of 18 g/L. The fibers were 6 mm long and 12 μm thick. The fibers are available from Fiber Innovation Technology, Inc., Johnson City, Tenn., USA.

1.5 g of citric acid were then added to the fiber-laden fluid, corresponding to a concentration of 4.3 g/L. The mixture was stirred manually. Very quickly, oleic acid precipitated and caused the fibers to bind together as flocs with a sticky consistency. The size of the flocs was about 10 cm.

### Example 3

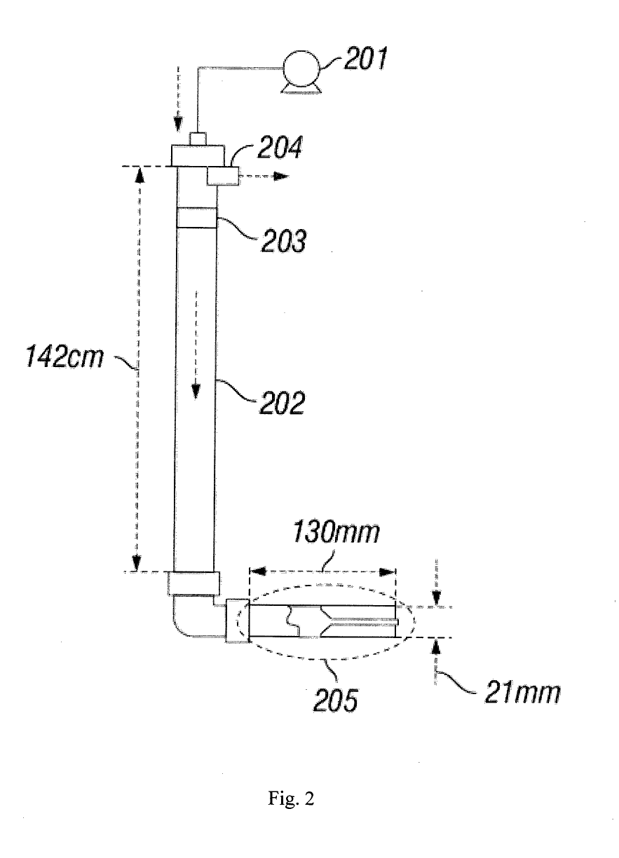

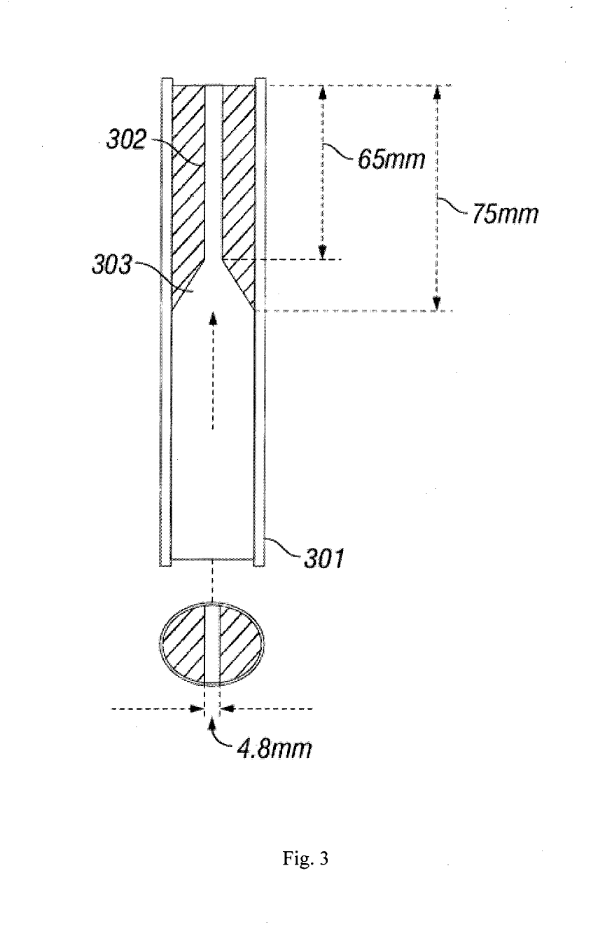

500 mL of the base fluid described in Example 1 were prepared. The same PLA fibers described in Example 2 were then added to and manually dispersed throughout the base fluid at a concentration of 18 g/L. Then, citric acid was added such that its concentration in the fluid was 5.3 g/L. The fiber-laden fluid containing the citric-acid flocculation initiator was then transferred to an apparatus described in FIGS. 2 and 3.

The apparatus was constructed by the inventors, and was designed to simulate fluid flow into a formation-rock void. A pump 201 is connected to a tube 202. The internal tube volume is 500 mL. A piston 203 is fitted inside the tube. A pressure sensor 204 is fitted at the end of the tube between the piston and the end of the tube that is connected to the pump. A slot assembly 205 is attached to the other end of the tube.

A detailed view of the slot assembly is shown in FIG. 3. The outer part of the assembly is a tube 301 whose dimensions are 130 mm long and 21 mm in diameter. The slot 302 is 65 mm long and 4.8 mm wide. Preceding the slot is a 10-mm long tapered section 303.

The pressure limit of the system is 3.5 MPa. When 3.5 MPa is reached, the pump shuts down and the slot is considered to be plugged.

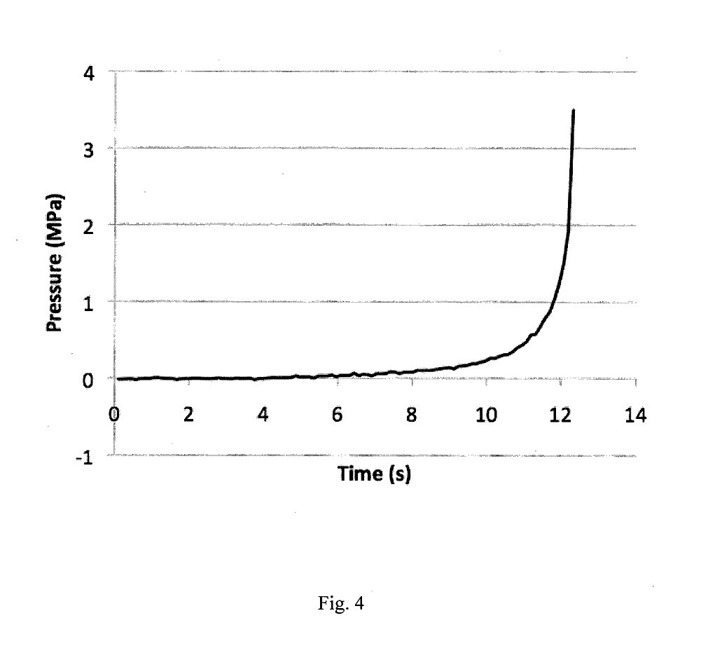

After transferring the test fluid to the tube 202, the piston 203 was inserted. The tube was sealed, and water was pumped behind the piston at a rate of 300 mL/min. This was equivalent to a velocity of 6.2 cm/s inside the slot 302. As shown in FIG. 4, the pressure rose to 3.5 MPa, and the pump shut down within 12 seconds.

### Example 4

An aqueous viscoelastic surfactant base fluid was prepared with the following composition: 1.8 wt % oleic acid, 0.2 wt % acetic acid, 5 wt % KCl and 0.6 wt % NaOH. In this experiment, calcium chloride was evaluated as a flocculation initiator. A 200 g/L calcium-chloride solution was prepared.

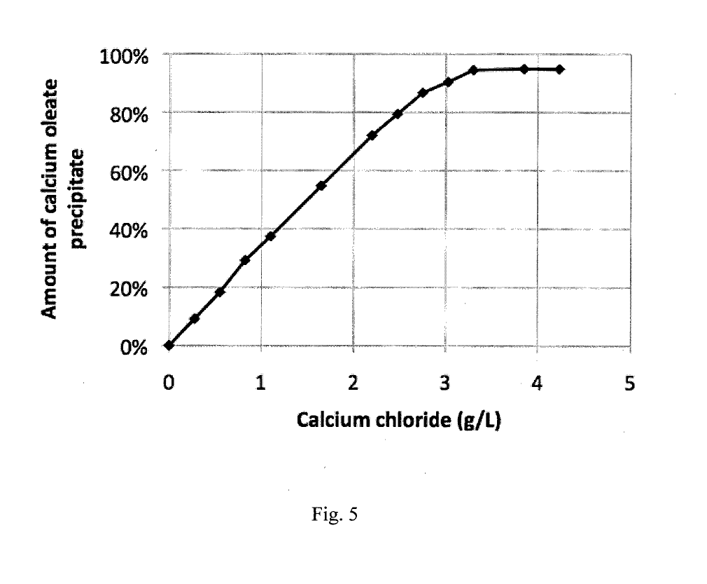

360 g of base fluid were placed in a container. The calcium chloride solution was added to the base fluid in 0.5-mL increments. After each increment, the weight of calcium oleate precipitate was measured. Based on the volume of base fluid and the oleic-acid concentration, the theoretical available mass of calcium-oleate precipitate was about 7 g. As shown in FIG. 5, calcium-oleate precipitation commenced immediately upon the addition of calcium chloride, and continued as additional aliquots of calcium chloride were introduced. Precipitation ceased after about 7 mL of calcium-chloride solution had been added. At this point, the calcium-chloride concentration in the base fluid was about 3.8 g/L. The final mass of the precipitate was 6.7 g.

### Example 5

500 mL of the base fluid described in Example 3 were prepared. The same PLA fibers described in Example 1 were added to the base fluid at a concentration of 18 g/L. Then, calcium chloride was added at a concentration of about 3.8 g/L, and the fiber-laden fluid was transferred to the apparatus described in Example 2.

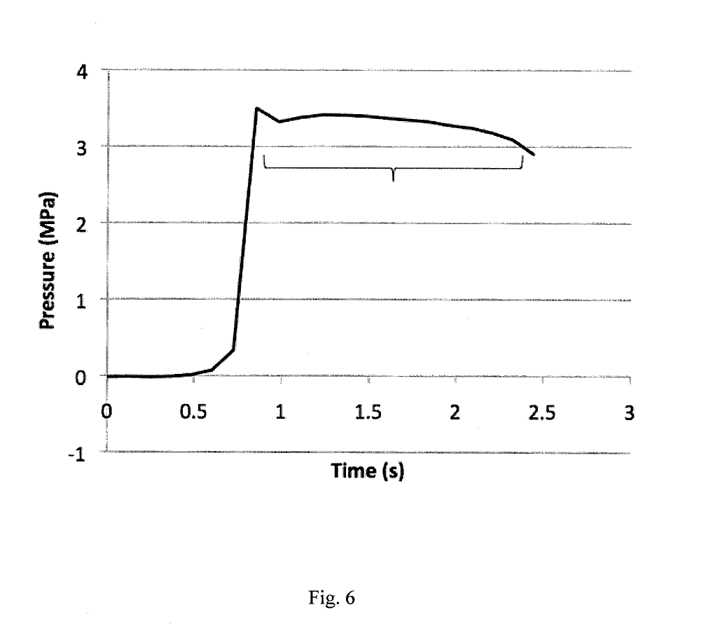

After transferring the test fluid to the tube, the piston was inserted. The tube was sealed, and water was pumped behind the piston at a rate of 300 mL/min. As shown in FIG. 6, the pressure rose to 3.5 MPa, and the pump shut down in less than one second. After the pump shut down, the system pressure remained the same, indicating that the flocculated plug was able to hold pressure.

### Example 6

350 mL of the base fluid described in Example 1 were prepared and placed in a beaker. The same PLA fibers described in Example 1 were added to the base fluid at a concentration of 18 g/L.

0.5 g of calcium hydroxide was then added to the fiber-laden fluid, corresponding to a concentration of 1.4 g/L. The mixture was stirred manually. Very quickly, calcium oleate precipitated and caused the fibers to bind together as flocs. The size of the flocs was about 3 cm.

1. A method for controlling fluid flow through one or more pathways in one or more rock formations penetrated by a borehole in a subterranean well, comprising injecting into or adjacent to the formation a treatment fluid comprising:
i. at least one viscoelastic surfactant;
ii. fibers, or a mixture of fibers and particles; and
iii. one or more flocculation initiators.

2. A method for curing lost circulation in a subterranean well penetrated by a borehole comprising injecting into or adjacent to the formation a treatment fluid comprising:
i. at least one viscoelastic surfactant;
ii. fibers, or a mixture of fibers and particles; and
iii. one or more flocculation initiators.

3. A method of treating a subterranean formation penetrated by a wellbore, comprising injecting into or adjacent to the formation a treatment fluid comprising:
i. at least one viscoelastic surfactant;
ii. fibers, or a mixture of fibers and particles; and
iii. one or more flocculation initiators.

4. The method of claim 1, wherein the flocculation initiator comprises one or more members of the list comprising: acids, bases, multivalent ions, mutual solvents, surfactants, polymers and oxidizers.

5. The method of claim 1, wherein the viscoelastic surfactant comprises a fatty-acid carboxylate.

6. The method of claim 1, wherein the viscoelastic-surfactant concentration is between about 0.2% and 20% by weight.

7. The method of claim 1, wherein the fibers comprise one or more members of the list comprising polylactic acid, polyester, polylactone, polypropylene, polyolefin and polyamide.

8. The method of claim 1, wherein the fiber concentration is between about 0.6% and 2.4% by weight.

9. The method of claim 1, wherein the fiber length is between about 2 mm and 25 mm, and the fiber diameter is between about 1 μm and 200 μm.

10. The method of claim 1, wherein the particles comprise one or more members of the list comprising polylactic acid, polyester, calcium carbonate, quartz, mica, clay, barite, hematite, ilmenite and manganese tetraoxide.

11. The method of claim 1, wherein the particle concentration is between about 6 g/L and 72 g/L.

12. The method of claim 1, wherein the particle size is between 5 μm and 1000 μm.

13. The method of claim 1, wherein the acid-flocculation initiator comprises a carboxylic acid.

14. The method of claim 1, wherein the treatment fluid further comprises one or more acid precursors chosen from the list comprising esters, lactones, amides, lactams and acid anhydrides.

15. The method of claim 1, wherein the concentration of the acid-flocculation initiator, the acid precursor or both is sufficient to reduce the treatment-fluid pH to a level below about 9.5.

16. The method of claim 1, wherein the multivalent-cation-flocculation initiator comprises one or more members of the list comprising calcium chloride, magnesium chloride, iron chloride, copper chloride, aluminum chloride, calcium hydroxide, calcium formate and calcium lactate gluconate.

17. The method of claim 1, wherein the multivalent-cation-flocculation initiator concentration is between about 0.01% and 10% by weight.

18. The method of claim 1, wherein the flocculation initiator is encapsulated.

19. The method of claim 18, wherein the encapsulated flocculation initiator is released by one or more mechanisms in the list comprising: time, hydrolysis, temperature, shear, pH change, vibration and irradiation.

20. The method of claim 1, wherein the treatment fluid further comprises a chelating agent comprising one or more members of the list comprising ethylene diamine tetraacetic acid, diethylene triamine pentaacetic acid, hydroxyethyl ethylene diamine triacetic acid, hydroxyethyl iminodiacetic acid and triethanolamine.
